(19) United States
(12) Patent Application Publication
(10) Pub. No.: US 2024/0357547 A1
(43) Pub. Date: Oct. 24, 2024

(54) AUTOMATED AND DYNAMIC LOCATION INTELLIGENCE BASED ON GPS DATA

(71) Applicant: Omnitracs, LLC, Westlake, TX (US)

(72) Inventor: Michal YARIV, Evanston, IL (US)

(21) Appl. No.: 18/306,047

(22) Filed: Apr. 24, 2023

(51) Int. Cl. H04W 64/00; H04L 67/306

(52) U.S. Cl. CPC H04W 64/003; H04L 67/306

(57) ABSTRACT

Aspects of the present disclosure relate to dynamically determining location attributes based on global positioning system (GPS) data. These techniques may include receiving GPS data from a plurality of devices associated with a physical structure. In addition, the techniques may include generating a virtual geofence around the physical structure based in part on GPS trajectory data derived from the GPS data, and determining one or more location attributes based on the virtual geofence. Further, the techniques may include presenting, via an application, the one or more location attributes within a site profile.

### BACKGROUND

Aspects of the present disclosure generally relate to data processing, and more particularly to dynamically processing location data to determine location intelligence.

Until the 18^{th} and 19^{th} centuries, most houses and buildings were not numbered. Street naming and numbering began under the age of enlightenment. Numbering allowed people to efficiently receive mail, as the postal system evolved to reach widespread usage. Today, the same postal system of associating locations with unique street addresses of where the person(s) at that address may receive mail continues. This typically correlates to a mailbox on the public street closest to a facility (e.g., home, business, or plot of land).

However, identifying a location based simply by the street address may not be ideal or precise for various logistics applications. For example, a location of interest (or “point-of-interest”) at a facility (e.g., a large retail store) with a significant footprint and multiple entry and exit points may vary for different users and applications. Customer parking, for instance, may be located at the front of the retail store and forbid specific types of traffic, while the location for deliveries may be located at a completely different part of the facility. Yet, the “street address” for the retail store may not be close to either location if the store is situated in a large multistore complex far from the main street. Further, navigational applications that provide directions to a front door of a facility may be ideal for customers of the facility but difficult for a large delivery vehicle trying to navigate to a delivery bay. Moreover, without knowledge of the services and amenities offered at the facility and/or the characteristics and performance history of the services of the facility, it may be difficult to manage driver workload, minimize shipping/delivery costs, and improve facility operations.

### SUMMARY

An example implementation includes a method comprising receiving global positioning system (GPS) data from a plurality of devices associated with a physical structure. The method further includes generating a virtual geofence around the physical structure based in part on GPS trajectory data derived from the GPS data. Additionally, the method further includes determining one or more location attributes based on the virtual geofence. Additionally, the method further includes presenting, via an application, the one or more location attributes within a site profile.

Another example implementation includes an apparatus executable by a network-based control computer, comprising a memory and a processor in communication with the memory. The processor is configured to receive global positioning system (GPS) data from a plurality of devices associated with a physical structure. The processor is further configured to generate a virtual geofence around the physical structure based in part on GPS trajectory data derived from the GPS data. Additionally, the processor further configured to determine one or more location attributes based on the virtual geofence. Additionally, the processor further configured to present, via an application, the one or more location attributes within a site profile.

Another example implementation includes a non-transitory computer-readable device having instructions thereon that, when executed by at least one computing device, cause the at least one computing device to perform operations comprising receiving global positioning system (GPS) data from a plurality of devices associated with a physical structure. Additionally, the operations further comprising generating a virtual geofence around the physical structure based in part on GPS trajectory data derived from the GPS data. Additionally, the operations further comprising determining one or more location attributes based on the virtual geofence. Additionally, the operations further comprising presenting, via an application, the one or more location attributes within a site profile.

The above presents a simplified summary of one or more aspects of the present disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the present disclosure in a simplified form as a prelude to the more detailed description that is presented later.

To the accomplishment of the foregoing and related ends, the one or more aspects of the present disclosure comprise the features hereinafter fully described and particularly pointed out in the claims. The following description and the annexed drawings set forth in detail certain illustrative features of the one or more aspects of the present disclosure. These features are indicative, however, of but a few of the various ways in which the principles of various aspects of the present disclosure may be employed, and this description is intended to include all such aspects and their equivalents.

### BRIEF DESCRIPTION OF THE DRAWINGS

The disclosed aspects of the present disclosure will hereinafter be described in conjunction with the appended drawings, provided to illustrate and not to limit the disclosed aspects, wherein like designations denote like elements, where a dashed line may indicate an optional element or action, and in which:

FIG. 1 is a functional block diagram of example elements of a system in accordance with various aspects of the present disclosure;

FIG. 2 is an example graphical user interface (GUI) displaying a profile that includes location attributes for a facility, in accordance with various aspects of the present disclosure;

FIG. 3 is an example GUI displaying a profile that includes a geofence for a facility, in accordance with aspects of the present disclosure;

FIG. 4 is an example GUI a profile that includes displaying physical structure information, in accordance with aspects of the present disclosure;

FIG. 5 is an example GUI displaying analytics information, in accordance with aspects of the present disclosure;

FIG. 6 is an example GUI displaying scheduling information, in accordance with aspects of the present disclosure;

FIG. 7 is a flowchart of an example method for data processing to determine and present location intelligence, in accordance with various aspects of the present disclosure; and

FIG. 8 is a block diagram of an example network computer device in accordance with the present disclosure.

### DETAILED DESCRIPTION

As noted above, identifying a location based simply by the street address may not be ideal or precise for various logistics applications. To this end, aspects of the present disclosure provide image processing techniques and data collection techniques to identify location attributes and scheduling information for different applications. Specifically, techniques of the present disclosure may generate a virtual geofence around the physical structure that then allows a network computer to receive and analyze GPS information received from a plurality of devices located within the virtual geofence over a period of time in order to generate and present location attributes, location analytics, and/or scheduling analytics for different applications. For example, the location attributes, the location analytics, and/or the scheduling analytics may provide improved clarity as to the services and amenities offered at a location, which may be used to reduce driver workload for safety reasons, minimize delivery costs, and improve facility operations in some logistics applications.

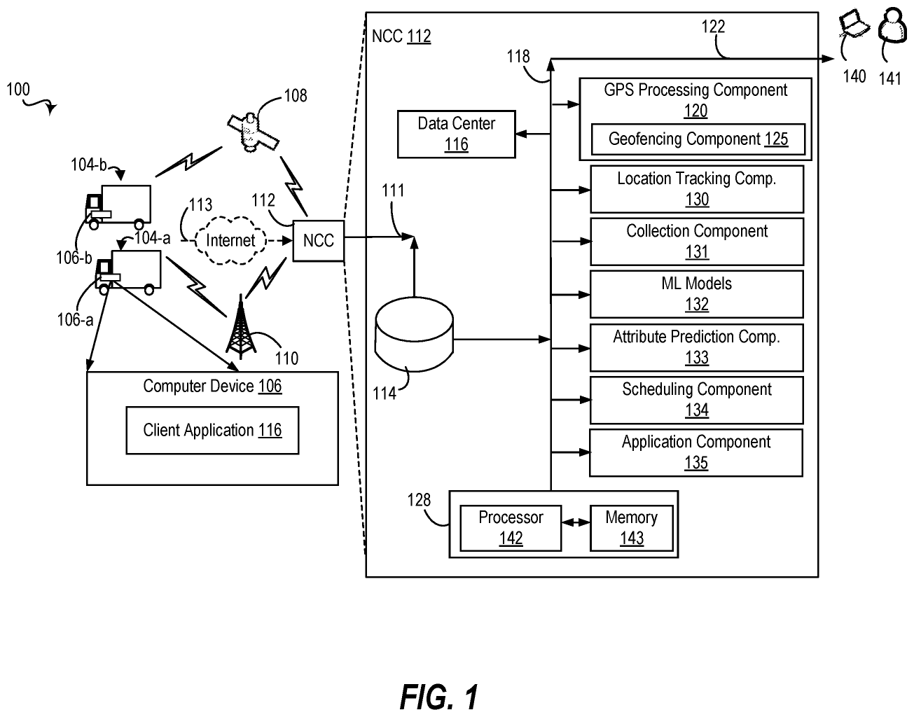

Various aspects are now described in more detail with reference to the FIGS. 1-8. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

The following description provides examples of implementations of the described system based on the principles described herein, but it should be understood that these examples are not intended to limit the scope of the claims. For instance, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined with other features described in other examples.

Referring to FIG. 1, in an aspect, a system 100 includes one or more computer devices, modules, and/or components for generating and managing dynamic location intelligence. As used herein, the terms “module(s),” or “components” may be one of the parts that make up a device, may be hardware or software or firmware, and may be divided into other modules and/or distributed across one or more processors.

In an aspect, system 100 can comprise a network-based control computer (NCC) 112, such as at a network management center, configured to communicate with one or more vehicles 104 via a computer device 106 (e.g., electronic logging device ELD and/or mobile device, etc.) located on each tractor 104 or associated with each driver of each tractor 104. In some systems, the computer device 106 may be more than one device, such as an ELD that may communicate with the mobile device (e.g., a smart phone or an in-cab telematics device). The system 100 may include one or more fleets of vehicles 104. Typically, a fleet could include many tens, hundreds or thousands of vehicles. An example fleet is illustrated as having two vehicles 104. Each computer device 106 may include ELD functionality configured to collect and transmit data associated with the driver to the NCC 112. Also, in some implementations, each computer device 106 and/or its ELD functionality can be configured to perform calculations associated with one or more fleet vehicles using any of the collected data. In some examples, the collected data may include the driver or vehicle data, such as but not limited to one or more of a vehicle identification, a driver identification, hours-of-service (HOS) information for the driver, a location of the vehicle 104, and/or telematics information associated with the vehicle 104 and/or driver, which will be collectively referred to as “vehicle information 109.”

For instance, in some aspects, the ELD may be synchronized with the vehicle and may record information, such as information required by 49 C.F.R. §§ 395. 15-16, including road speed and/or vehicle engine revolutions per minute (“RPM”). In an embodiment, the ELD(s) may be in communication with various vehicle sensors, such as a speedometer, tachometer, fuel gauge, scale, odometer, accelerometer, compass, Global Positioning System (“GPS”) receiver, etc., and may record information received from the various vehicle sensors as vehicle status information. In an embodiment, the ELD may wirelessly transfer vehicle status information, such as vehicle motion and vehicle stops, to the NCC 112.

In some examples, telematics is an interdisciplinary field that encompasses telecommunications, vehicular technologies, for instance, road transportation, road safety, electrical engineering (sensors, instrumentation, wireless communications, etc.), and computer science (multimedia, Internet, etc.). To this end, the telematics technology may include transmitting, receiving and storing information (e.g., vehicle and/or driver information) using telecommunication devices to control remote objects such as control one or more applications and aspects of the vehicles (e.g., control the braking and engine of the vehicle).

In an example implementation, the one or more vehicles 104 may be equipped with the computer device 106 in the form of a mobile device in communication with a separate ELD, where the mobile device may function as an in-cab telematics device. As used herein, the term “mobile device” is used interchangeably herein to refer to any one or all of cellular telephones, smartphones, personal or mobile multi-media players, personal data assistants (PDA's), personal computers, laptop computers, tablet computers, smart books, palm-top computers, wireless electronic mail receivers, multimedia Internet enabled cellular telephones, wireless gaming controllers, in vehicle displays, computer kiosks, and similar personal electronic devices which include a programmable processor and memory and circuitry for receiving driver input, displaying a web browser, and connecting to the Internet. For example, in some aspects, the mobile device may be a smart phone or tablet configured to receive and process signals and information. In some other examples, the mobile device may be a navigational head unit and/or a cellular telephone paired to a navigational head unit. In some instances, the ELD may be in communication with the mobile device to allow the collected information to be displayed on the mobile device. To this end, the computer device 106 in the form of either the ELD or the mobile device may include a client application 107 to perform one or more functions of the present disclosure, including collecting and transmitting and receiving driver and/or vehicle data to and from a remote NCC 112 and/or configuring the vehicle to present location attributes and scheduling information to a driver.

In some implementations, the computer device 106 may include a processor configured to execute the client application 107 and establish communication with external devices, such as NCC 112, via a communication network (e.g., a terrestrial or satellite-based wireless network). The computer device 106 may also include a memory configured to store computer-readable code that may define all or part of the client application 107 and also to store data associated with the client application 107, other components, and/or computer device 106. The computer device 106 may also include a user interface or display, a mobile application server, and a communications component (e.g., including the one or more transceivers, and one or more of terrestrial and Wi-Fi modems, one or more antennae, a GPS and/or satellite communications modem).

As an example only, each vehicle 104 may be in bi-directional communication via the computer device 106 with NCC 112 over at least one communication channel. In the example shown in FIG. 1, each vehicle 104 is in bi-directional communication with the NCC 112 over at least one of a satellite-based communication system 108 or a terrestrial-based communication system 110 (e.g., a wireless communication system using a communication protocol/technology such as, but not limited to, 5G or New Radio, GSM, CDMA. TDMA, WCDMA, EDGE, OFDM, GPRS, EV-DO, LTE, WiFi, Bluetooth), or, when the vehicle is stopped, via a wired connection 113 through the Internet. In some cases, data may be exchanged with the vehicles 104 using one or more communication networks (e.g., one or both of the satellite-based communication system 108 and the terrestrial-based communication system 110).

In an aspect, many different types of data are collected and transferred from the vehicles 104 to the NCC 112. Examples of such data include, but are not limited to, vehicle performance data, driver performance data, critical events, messaging and position data, location data, HOS data and many other types of data, which may be collectively referred to as vehicle data 109. All of the information that is communicated to and from the vehicles 104 may be processed via the NCC 112. The NCC 112 can be thought of as a data clearinghouse that receives all data that is transmitted to and received from the vehicles 104. In an aspect, NCC 112 may include one or more back-end servers. Thus, in some aspects, the collected information may periodically (e.g., every x minutes or once a day, or upon availability of a wired or wireless connection) be transmitted from the computer device 106 to the NCC 112 for analysis and record keeping.

In some cases, the system 100 also may include a data center 116, which may be part of or in communication with NCC 112. The data center 116 illustrates one possible implementation of a central repository for all of the data received from each of the vehicles 104. As an example, as mentioned above many different types of data are transmitted from the computer devices 106 associated with each of the vehicles 104 to the NCC 112. In the case where the data center 116 is in communication with the NCC 112, the data may be transmitted via connection 111 to the data center 116. The connection 111 may comprise any wired or wireless dedicated connection, a broadband connection, or any other communication channel configured to transport the data. Moreover, in an aspect, data center 116 may include one or more back-end servers analyzing the data transmitted from the one or more computer devices 106. Additionally or alternatively, data may also be exchanged between the plurality of computer devices 106 using, for example, peer-to-peer (P2P) communication without the involvement of the NCC 112.

In an aspect, the data center 116 may include a data store 114 for receiving the data from the computer device 106 relating to the vehicle 104. In an aspect, for example, data center 116 may include any number of application servers and data stores, where each may be associated with a separate fleet and/or driver management or performance data. In an aspect, each application server and data store may include a processor, memory including volatile and non-volatile memory, specially-programmed operational software, a communication bus, an input/output mechanism, and other operational systems. For example, an application server may be a services portal (SP) server that receives, for example, messaging and positioning (M/P) data from each of the vehicles 104. Another application server, for example only, may include one or more servers related to safety and compliance, such as a quick deployment center (QDC) server that receives, for example, critical event (CE) data from each of the vehicles 104. Further, for example, another application server may be vehicle and driver performance data related to HOS, fuel usage, and/or cost from each of the vehicles 104. It should be understood that the above list of example servers is for illustrative purposes only, and data center 116 may include additional and/or different application servers.

In some examples, the NCC 112 may include an GPS processing component 120 for processing geospatial image of a geographic area that includes a physical structure at a specified geographic coordinates. In some examples, the geofencing component 125 may generate a virtual geofence around the physical structure by leveraging GPS data received from one or more devices that track the GPS trajectory (or vector) and/or monitored stationary positions (e.g., guard sheds, loading areas, unloading areas, waiting areas, etc.). Specifically, a GPS processing component 120 may rely on GPS data from multiple trips and/or multiple vehicles to identify GPS trajectories and form a virtual boundary that can further analyzed based on GPS information to generate locations of interest. For example, one or more techniques may include receiving, at the network-based control computer, global positioning system (GPS) data from a plurality of devices, grouping the GPS data from the plurality of devices to generate GPS trajectory information for each group of the plurality of devices, and calculating kernel density estimation based on the GPS trajectory information. The method may further include determining an isoline on a virtual map for each group of the plurality of devices based on the kernel density estimation, overlaying the isoline data on a geographic coordinate information of a physical structure, and generating a virtual geofence around the physical structure based in part on overlaying the isoline data to the geographic coordinate information of the physical structure. Once the geofence information is established, the method may include storing, in a memory of the network-based control computer, geofence information for the facility based on the virtual geofence that is created around the physical structure. By way of background for geofencing, U.S. patent application Ser. Nos. 17/169,431 and 17/175,225 (now U.S. Pat. No. 11,533,583) are incorporated herein by reference.

Once the virtual geofence has been established, the location tracking component 130 may receive and analyze GPS information (e.g., GPS “pings”) received from a plurality of devices (e.g., computer devices 106 configured to provide location information such as GPS tracking devices or mobile phones, etc.) located within the virtual geofence over a period of time in order to generate locations of interest information for different applications by tracking the density of the GPS clusters. For instance, within the established virtual geofence, the location tracking component 130 may track the location of passenger vehicles or delivery trucks over time to determine the precise location around the physical structure where the devices tend to remain stationary for extended periods of time. Such information would then allow location tracking component 130 to differentiate location of interests for each application (e.g., for logistics applications the location of delivery parking as opposed to customer parking areas, etc.).

In some examples, the NCC 112 may include a collection component 131 for collecting, analyzing, and managing data about a plurality of locations of interest. For example, in some aspects the collection component 131 may collect data associated with a facility from one or more data sources and determine one or more location attributes based on the data. Some examples of the data sources include websites, audio/video media, transcripts, text documents, user generated comments/reviews, user messages, in-cab cameras, etc. As an example, in some aspects, the collection component 131 may scrape a website for data associated with a facility. In some other examples, the collection component 131 may retrieve textual information from a website including a description and/or reviews of the facility. As yet still another example, the collection component 131 may access an application or website associated with the NCC 112 that receives and/or displays feedback (e.g., reviews, comments, customer service inquiries, usage reports) authored by the drivers of the vehicles 104, and retrieves the feedback. In some aspects, the collection component 131 may be configured to convert data from a non-textual media format to a text format. For example, the collection component 131 may identify an audio content item corresponding to a facility and perform a speech recognition process to generate a textual representation/description of the audio content item. As another example, the collection component 131 may identify an audio-visual content item corresponding to a facility and perform a speech recognition process, sentiment and/or character recognition to generate a textual representation/description of the audio-visual content item.

In some aspects, the collection component 131 may manage the freshness and/or accuracy of the data collected from the data sources. For example, in some aspects, the collection component 131 may replace data previously collected from a data source with data recently collected by the collection component 131 based upon the data previously collected from the data source being older. As another example, the collection component 131 may replace first data collected from a data source with second data collected by the collection component 131 based upon the second data being more accurate than the first data. For instance, in some aspects, the collection component 131 may generate confidence values for the collected data, and manage the collected data and/or the location attributes derived from the collected data based on the confidence values. In some aspects, the confidence value may be based on the source of the data, age of the data, sentiment of the data, and/or one or more other attributes of the data. For example, the collection component 131 may collect an anonymous review from a third-party website and assign a lower level of confidence. As another example, the collection component 131 may collect notes from a computer device 106 of a vehicle 104, and assign a higher level of confidence. Further, the collection component 131 may apply weights to a collected data item to reflect the confidence value of the collected data item. In some aspects, the collection component 131 may employ pattern recognition or machine learning (ML) techniques to determine the confidence value of collected data. For example, the collection component 131 may employ one or more ML models 132 to determine the confidence value of collected data.

In some examples, the NCC 112 may include an attribute prediction component 133 for predicting local attributes of the locations of interest. For example, in some aspects, the attribute prediction component 133 may determine a local attribute based on the virtual geofence associated with the facility, the location information associated with the facility, collected data associated with the facility, and/or data received from the one or more computer devices 106. Some examples of the location attributes include entry point(s), exit point(s), restroom availability, restroom location, lumper information (e.g., lumper availability, number of lumpers, etc.), breakroom availability, breakroom location, vending machine information (e.g., vending machine availability, type of vending machine(s), number of vending machines, vending machine location, etc.), shower availability, wireless availability, overnight parking availability, safety requirements, service information, site procedure information (e.g., covid-19 protocol), location type (e.g., loading station and/or unloading station), hours of operation, closure information, appointment types, and/or contact information.

Further, in some examples, the attribute prediction component 133 may employ the one or more machine learning models 132 to determine the location attributes for a facility based on a virtual geofence generated for the facility by the geofencing component 125, location information generated for the facility by the location tracking component 130, and/or data collected with respect to the facility by the collection component 131. In some aspects, the location information may identify the trajectories, stops, and movement of vehicles and drivers within the geofence. For example, the one or more ML models 132 may determine the entry point and/or exit point of the facility based on the location information identifying the trajectories of one of more vehicles 104 within the virtual geofence and/or area around the facility. In some aspects, an entry point may be recognized based on a location where one or more vehicles cross into a geofence, and an exit point may be recognized based on a location where one or more vehicles leave a geofence. As another example, the one or more ML models 132 may determine business hours of the facility based upon the location information identifying the trajectories of one of more vehicles 104 within the virtual geofence and a website listing the hours of operation for the facility. As yet still another example, the one or more ML model 132 may determine whether there is wireless availability at the facility based on the data received from the one or more computer devices while the one of more vehicles are located within the virtual geofence. As yet still another example, the one or more ML model 132 may determine whether there is overnight parking availability at the facility based on the data received from the one or more computer devices while the one of more vehicles are located within the virtual geofence, and/or the arrangement of the vehicles 104 within the virtual geofence. As yet still another example, the one or more ML model 132 may determine lumper information, location type, and/or closure information from web reviews of the facility and/or location information identifying the trajectories of one of more vehicles 104 within the virtual geofence.

In some examples, the NCC 112 may include a scheduling component 134 for predicting schedule information for facilities. In some aspect, the NCC 112 may include a scheduling component 134 for predicting schedule information for facilities based on historic scheduling information, historic location information, historic dwell time, historic detain information, etc. Further, in some aspects, the scheduling component 134 may employ the one or more ML models 132 to predict the dwell time, distribution of dwell times, driver arrival/departure patterns, driving directions, expected load time, expected unload time, a scheduled time for reducing load and/or unload times, likelihood of detainment, routes and/or appointments for lowest end to end service duration, and/or a scheduled time for reducing likelihood of detainment for the locations of interest. In addition, in some aspects, the scheduling component 134 may be used to predict delivery costs (e.g., end-to-end costs) based on the predicted scheduling information.

In some aspects, the one or more ML models 132 may include neural network models, deep learning models, convolutional neural network models, recurrent neural network models, regression network models, decision tree models, random forest models, support vector machine models, naive bayes models, natural language processing models, and/or other artificial intelligence/ML models for classification and/or prediction. In some aspects, a “neural network” may refer to a mathematical structure taking an object as input and producing another object as output through a set of linear and non-linear operations called layers. Such structures may have parameters which may be tuned through a learning phase to produce a particular output, and are, for instance, used for classifying a location as a particular type of location type.

In some aspects, the NCC 112 may further communicate with one or more terminal devices 140(1)-(n), which can be a user interface portal, a web-based interface, a personal computer (PC), a laptop, a personal data assistant (PDA), a smart phone, a dedicated terminal, a dumb terminal, or any other device over which a user 141, such as a manager or operator responsible for monitoring a fleet of vehicles 104, may communicate.

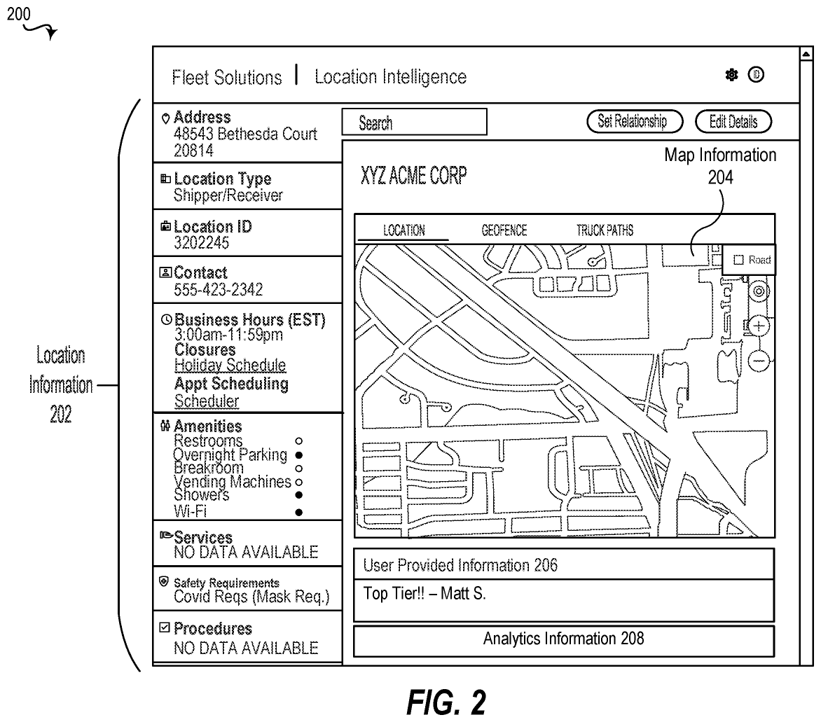

Further, the NCC 112 may include an application component 135 for generating and presenting location profiles for the locations of interest to the terminal devices 140. Some examples of the application component include web applications, web services, websites, apps, cloud applications, cloud services, back-ends, application programming interface servers, programs, software, etc. For instance, in some aspects, the application component 135 may receive a request (e.g., a search query) for information associated with a facility, and transmit a response including a profile for the facility. Further, in some aspects, the response may cause a computer device 106 or the terminal device 140 to display a graphical user interface including the profile, as illustrated in FIGS. 2-6. For example, the application component 135 may cause the GUIs of FIGS. 2-6 to be displayed on a display device of a computer device 106 or a terminal device 140. Further, in some aspects, a profile of a particular facility may be presented on a display device of a computer device 106 when the associated vehicle is in route to the facility or within predefined distance of the facility. As such, the driver may use the location attributes and/or the scheduling information of the profile to plan travel arrangements.

In an aspect, the NCC 112 and/or the data center 116 may include a processor 142 and a memory 143 to respectively execute and store instructions and data associated the operation of the data center 116, such as to operate the GPS processing component 120, the location tracking component 130, the collection component 131, the one or more ML models 132, the attribute prediction component 133, the scheduling component 134, and the application component 135. Although shown as residing within the data center 116, the analysis engine may reside elsewhere, and may be implemented as a distributed system in which the processor 142 and the memory 143 may include one or more processor and memories, and may be located in different places, such as at NCC 112 and/or one or more servers associated with NCC 112 or data center.

The information generated by the location tracking component 130 based on the virtual geofence may be used in practical logistics applications including, for example, identifying a location of interest at the physical structure that is within the virtual geofence. The location of interest includes docking stations or parking spaces tailored to accommodate trucks or other vehicles and configuring a vehicle 104 to display the location of interest on a display screen located within the vehicle 104 (e.g., on the computer device 106). The system may also allow for generating a notice when a GPS data associated with a device (e.g., computer device 106) indicates that the device has either entered or exited the virtual geofence around the physical structure. The notice may include a message indicating that the device has arrived or departed the physical structure, and transmitting the notice to a remote computer identifying when the device has entered or exited the physical structure.

Additionally or alternatively, other practical applications may include detecting that a device (e.g., computer device 106), in route to the physical structure, is within a predetermined distance of the virtual geofence around the physical structure based on a GPS data associated with the device. The detection may trigger the computer device 106 or the NCC 112 to generate a notice indicating that the device will be arriving at the physical structure within a specified time period based on detecting that the device is within the predetermined distance of the virtual geofence. The computer device 106 or the NCC 112 may transmit the notice to a remote dispatcher prior to arrival at the physical structure.

Referring to FIG. 2, in an aspect, the NCC 112 may generate a GUI 200 displaying a profile that includes location attributes for a facility, in accordance with some aspects of the present disclosure. As illustrated in FIG. 2, the GUI 200 may include location information 202, map information 204, user provided information 206, and analytics information 208. In some aspects, the location information 202 may include location attributes determined by an attribute prediction component (e.g., the attribute prediction component 133). Some examples of the location attributes include address information, location type, location identifier, contact information, operating hours information, closure information, available amenities, available services, safety requirements, and/or special procedures. Additionally, the map information 204 may include a map of the location interest. In addition, the user provided information 206 may display comments, reviews, feedback, and other information provided by a user, e.g., a comment provided by the user 141 via the terminal device 140. Further, the analytics information 208 may include analytics and/or scheduling information determined by an attribute prediction component (e.g., the attribute prediction component 133) or a scheduling component (e.g., the scheduling component 134).

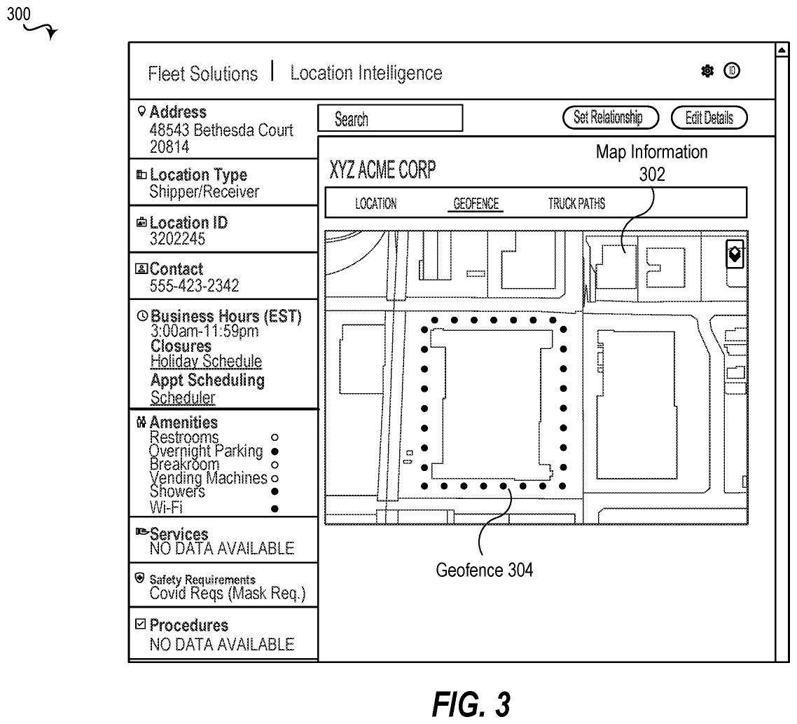

Referring to FIG. 3 in an aspect, the NCC 112 may generate a GUI 300 displaying a profile that includes a geofence for a facility, in accordance with some aspects of the present disclosure. As illustrated in FIG. 3, the GUI 300 may include map information 302. Further, in some aspects, the map information 302 may include a geofence 304 determined by a geofencing component (e.g., the geofencing component 125). In some aspects, the geofence 304 may assist drivers in determining confines of a physical structure located at the facility.

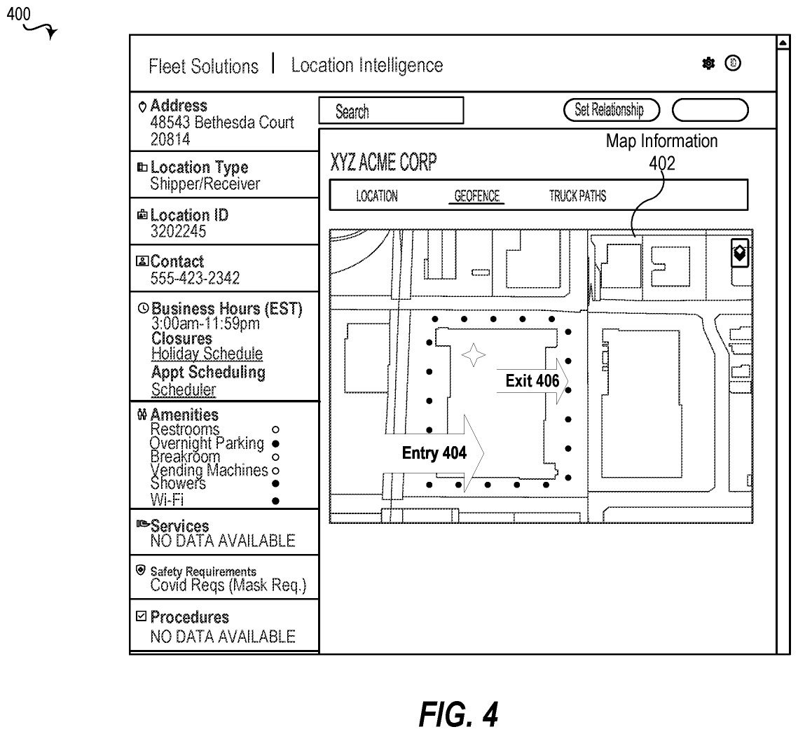

Referring to FIG. 4 in an aspect, the NCC 112 may generate a GUI 400 displaying a profile that includes physical structure information, in accordance with some aspects of the present disclosure. As illustrated in FIG. 4, the GUI 400 may include a map information 402. Further, in some aspects, the map information 402 may include an entry indicator 404 and an exit indicator 406. Further, as described herein, in some aspects, the entry indicator 404 and the exit indicator 406 may be determined by an attribute prediction component (e.g., the attribute prediction component 133). In some aspects, the graph representations 502(1)-(3) may be based on information collected by the location tracking component 130 and the collection component 130 and generated by the location tracking component 130 and/or the attribute prediction component 134. Further, in some aspects, the GUI 400 may be presented with or within a GUI displaying profile (e.g., the FIGS. 2-4).

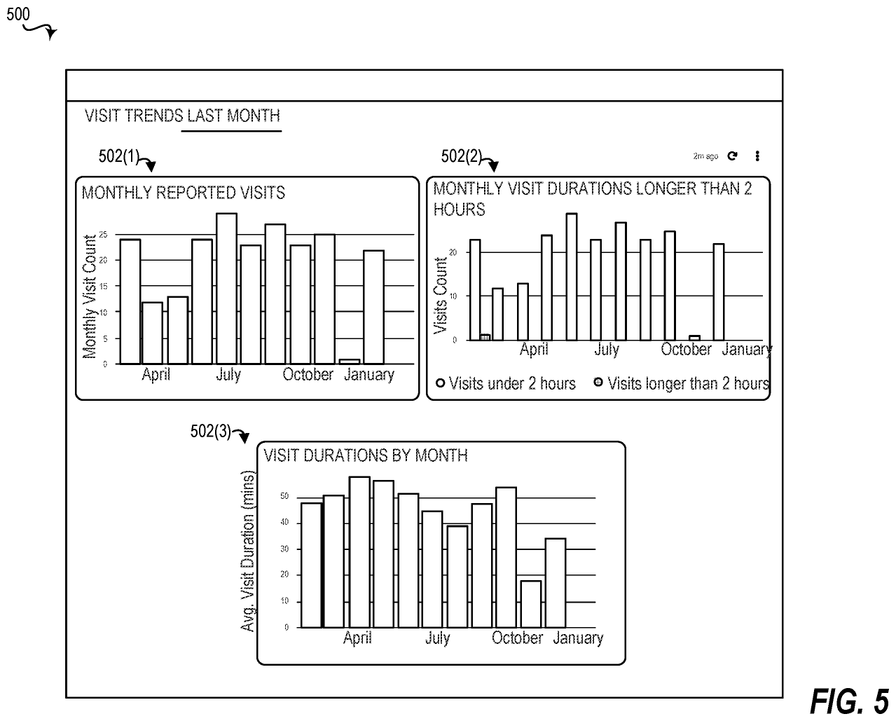

Referring to FIG. 5 in an aspect, the NCC 112 may generate a GUI 500 that includes analytics information, in accordance with some aspects of the present disclosure. As illustrated in FIG. 5, the GUI 500 may include graph representations 502(1)-(3) of analytic information determined by an attribute prediction component (e.g., the attribute prediction component 133). Although FIG. 5 illustrates three graph representations, the GUI 500 may include any number of graph representations to display the location attributes determined by the attribute prediction component. In some aspects, the graph representations 502(1)-(3) may be based on information (e.g., the) collected by the location tracking component 130 and the collection component 130 and generated by the location tracking component 130, the attribute prediction component 134, and/or the scheduling component 135. Further, in some aspects, the GUI 500 may be presented with or within a GUI displaying profile (e.g., the FIGS. 2-4).

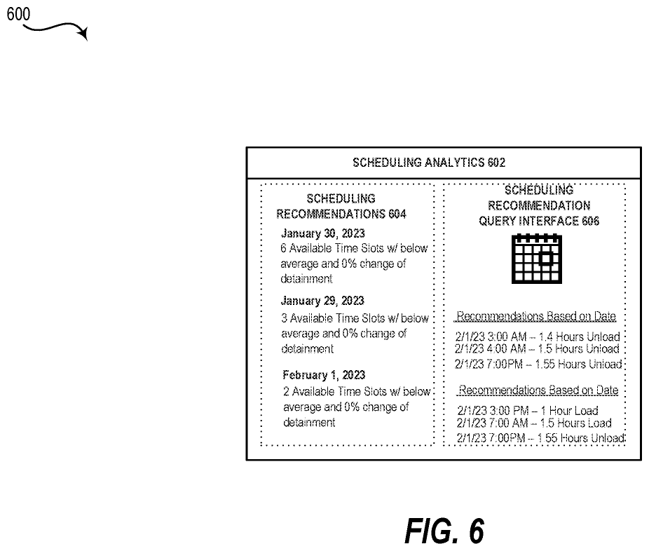

Referring to FIG. 6 in an aspect, the NCC 112 may generate a GUI 600 that includes scheduling information, in accordance with some aspects of the present disclosure. As illustrated in FIG. 6, the GUI 600 may include scheduling information 602. Further, in some aspects, the scheduling information 602 may include scheduling recommendations 604 and a scheduling recommendation query interface 606. The scheduling recommendations 604 may show one or more recommended times and dates determined to be best for receiving service at the facility, as determined by a scheduling component (e.g., scheduling component 134). In some aspects, the scheduling component 134 may determine the recommended times and dates based on query attributes provided by a user. For example, the user may indicate that the scheduling component 134 should minimize dwell time, maximize the number of lumpers, or display locations of interest with smallest likelihood of detainment. Further, scheduling recommendation query interface 606 may receive a date of interest from a user and present one or more recommended times for receiving service at the facility. In some aspects, the scheduling component 134 may determine the recommended times and dates based on query attributes provided by a user. For example, the user may indicate that the scheduling component 134 should minimize dwell time, maximize the number of lumpers, or display locations of interest with smallest likelihood of detainment.

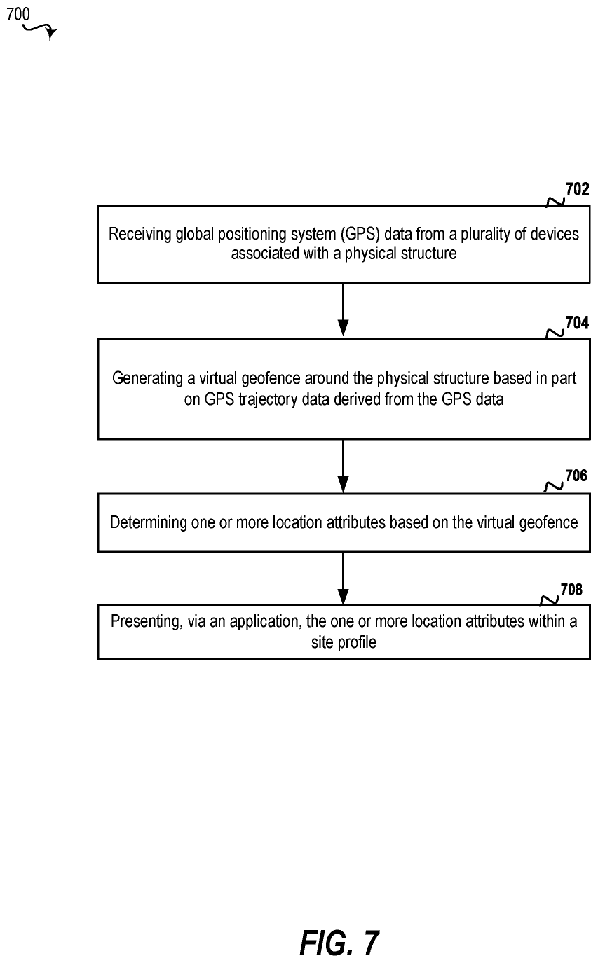

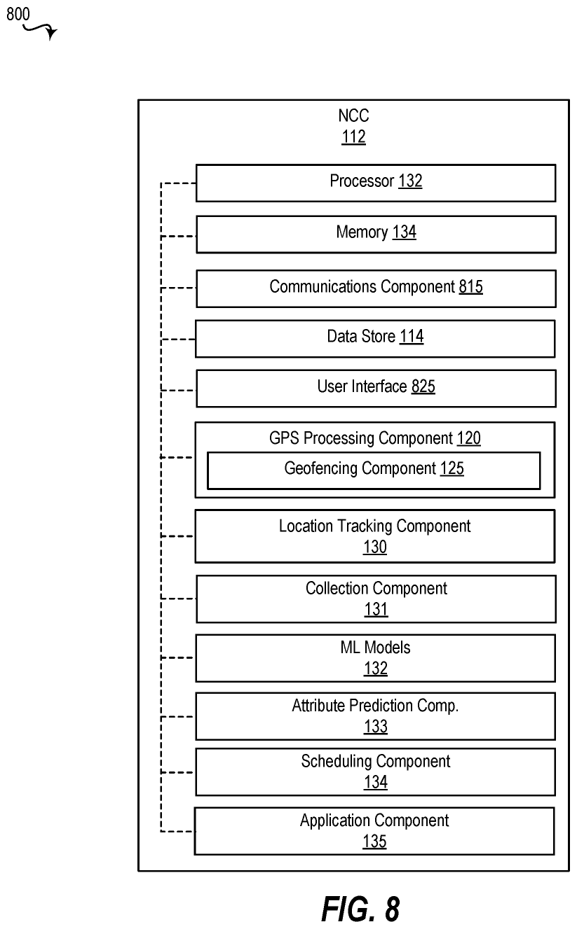

Referring to FIG. 7, one example of a method 700 for data processing to determine and present location intelligence, in accordance with various aspects of the present disclosure may be performed by the NCC 112 discussed with reference to FIG. 1. In some examples, the method 700 may be performed by a processor (e.g., processor 142 with reference to FIGS. 1 and 8), such as by executing instructions stored in the memory (e.g., memory 143 with reference to FIGS. 1 and 8). It should be appreciated that the below identified operation of the method 700 is just one example to identify locations of interests. Indeed, the method 700 may be modified to change an order in which the steps are performed.

At block 702, the method 700 may include receiving global positioning system (GPS) data from a plurality of devices associated with a physical structure. For example, the communications component 815 may receive GPS data from the plurality of computer devices 106 via a communication network (e.g., satellite-based communication system 108, the terrestrial-based communication system 110, and the wired connection 113), and provide the GPS data to the location tracking component 130. In some aspects, the GPS data may include geographic coordinates (e.g., longitude and latitude coordinates of the physical structure). Additionally, the physical structure may be a warehouse, a shipping physical structure, or a physical location that includes access for trucks or large vehicles (e.g., semi-trucks, delivery trucks or vans etc.). Aspects of block 702 may be performed by the communications component 815 and the location tracking component 130 described with reference to FIGS. 1 and 8.

At block 704, the method 700 may include generating a virtual geofence around the physical structure based in part on GPS trajectory data derived from the GPS data. For example, the geofencing component 125 may group the GPS data from the plurality of computer devices 106 to generate GPS trajectory information for a group of the plurality of devices, and calculate kernel density estimation based on the GPS trajectory information. Further, the geofencing component may determine an isoline on a virtual map for the group based on the kernel density estimation, overlay the isoline data on a geographic coordinate information of a physical structure, and generate a virtual geofence around the physical structure based in part on overlaying the isoline data to the geographic coordinate information of the physical structure. Further, once the GPS processing component 120 identifies the boundary edges of the physical structure, the geofencing component 125 may extract a first boundary outline of the physical structure for virtual geofencing. Subsequently, the geofencing component 125 may calculate a second boundary outline offset outside of the first boundary line based on an offset value. The offset value may be variable or a fixed parameter. For example, the geofencing component 125 may determine a first set of latitude and longitude coordinates for a first plurality of geographic points of the first boundary outline, and identify a second set of latitude and longitude coordinates for a second plurality of geographic points by stepping out and away from each of the first set of latitude and longitude coordinates by a geographic distance defined by the offset value. Thus, the geofencing component 125 may determine the second boundary outline based on the second set of latitude and longitude coordinates.

In another example, the geofencing component 125 in collaboration with GPS processing component 120 may determine a first set of latitude and longitude coordinates for a first plurality of geographic points of the first boundary outline and convert the first set of latitude and longitude coordinates into a first set of pixel space coordinates for a first plurality of pixels of the first boundary outline. The geofencing component 125 and GPS processing component 120 may also identify a second set of pixel space coordinates for a second plurality of pixels by stepping out and away from each of the first set of pixel space coordinates by a pixel space distance defined by the offset value. Again, as noted above, the offset value may be variable (e.g., depending on location) or fixed offset value. The GPS processing component 120 may then convert the second set of pixel space coordinates into a second set of latitude and longitude coordinates for a second plurality of geographic points, and determine the second boundary outline based on the second set of latitude and longitude coordinates. The second boundary outline may then be utilized by the geofencing component 125 as the basis for generating a virtual geofence around a physical structure (e.g., warehouse, a shipping physical structure, or a physical location that includes access for vehicles).

Aspects of block 704 may be performed by the geofencing component 125 described with reference to FIGS. 1 and 8.

At block 706, the method 700 may include determining one or more location attributes based on the virtual geofence. For example, the attribute prediction component 133 may employ the one or more machine learning models 132 to determine the location attributes for a facility based on a virtual geofence generated for the facility by the geofencing component 125, location information generated for the facility by the location tracking component 130, and/or data collected with respect to the facility by the collection component 131.

Aspects of block 706 may be performed by the geofencing component 125, collection component 131, the one or more ML models 132, and the attribute prediction component 133 described with reference to FIGS. 1 and 8.

At block 708, the method 700 may include presenting, via an application, the one or more location attributes within a site profile. For example, the application component 135 may transmit a response including site information for a facility. Further, the site information may cause a terminal device 140 to display a graphical user interface location attributes determined by the attribute prediction component 133 and scheduling information determined by the scheduling component 134, as illustrated in FIG. 2. Further, as described herein, the terminal device 140 may employ an application to display the graphical user interface on the terminal device 140. Aspects of block 708 may be performed by the application component 135 described with reference to FIGS. 1 and 8.

Referring to FIG. 8, in an example that should not be construed as limiting, the NCC 112, may include additional components that operate in conjunction with the GPS processing component 120, the location tracking component 130, the collection component 131, the one or more ML models 132, the attribute prediction component 133, the scheduling component 134, and the application component 135, and may be implemented in specially programmed computer readable instructions or code, firmware, hardware, or some combination thereof.

In an aspect, for example, features described herein with respect to the functions of the GPS processing component 120, the location tracking component 130, the collection component 131, the one or more ML models 132, the attribute prediction component 133, the scheduling component 134, and the application component 135 may be implemented in or executed using one or any combination of processor 142, memory 143, communications component 815, and data store 114. For example, the GPS processing component 120, the location tracking component 130, the collection component 131, the one or more ML models 132, the attribute prediction component 133, the scheduling component 134, and the application component 135 may be defined or otherwise programmed as one or more processor modules of processor 142. Further, for example, the GPS processing component 120, the location tracking component 130, the collection component 131, the one or more ML models 132, the attribute prediction component 133, the scheduling component 134, and the application component 135 may be defined as a computer-readable medium (e.g., a non-transitory computer-readable medium) stored in memory 143 and/or data store 114 and executed by processor 142. Moreover, for example, inputs and outputs relating to operations of the GPS processing component 120, the location tracking component 130, the collection component 131, the one or more ML models 132, the attribute prediction component 133, the scheduling component 134, and the application component 135 may be provided or supported by communications component 815, which may provide a bus between the modules of NCC 112 or an interface for communication with external devices or modules.

Processor 142 can include a single or multiple set of processors or multi-core processors. Moreover, processor 142 can be implemented as an integrated processing system and/or a distributed processing system. Memory 143 may operate to allow storing and retrieval of data used herein and/or local versions of applications and/or software and/or instructions or code being executed by processor 142, such as to perform the respective functions of the GPS processing component 120, the location tracking component 130, the collection component 131, the one or more ML models 132, the attribute prediction component 133, the scheduling component 134, and the application component 135 described herein. Memory 143 can include any type of memory usable by a computer, such as random access memory (RAM), read only memory (ROM), tapes, magnetic discs, optical discs, volatile memory, non-volatile memory, and any combination thereof.

Communications component 815 is operable to establish and maintain communications with one or more internal components/modules or external devices utilizing hardware, software, and services as described herein. Communications component 815 may carry communications between modules on NCC 112, as well as between user and external devices, such as devices located across a communications network and/or devices serially or locally connected to NCC 112. For example, communications component 815 may include one or more buses, and may further include transmit chain modules and receive chain modules associated with a transmitter and receiver, respectively, or a transceiver, operable for interfacing with external devices.

Additionally, data store 114, which can be any suitable combination of hardware and/or software, which provides for mass storage of information, databases, and programs employed in connection with aspects described herein. For example, data store 114 may be a data repository for applications not currently being executed by processor 142.

The NCC 112 may additionally include a user interface module 825 operable to receive inputs from a user, and further operable to generate outputs for presentation to the user. User interface module 825 may include one or more input devices, including but not limited to a keyboard, a number pad, a mouse, a touch-sensitive display, a navigation key, a function key, a microphone, a voice recognition module, any other mechanism capable of receiving an input from a user, or any combination thereof. Further, user interface module 825 may include one or more output devices, including but not limited to a display, a speaker, a haptic feedback mechanism, a printer, any other mechanism capable of presenting an output to a user, or any combination thereof.

The NCC 112 may also include the GPS processing component 120, the location tracking component 130, the collection component 131, the one or more ML models 132, the attribute prediction component 133, the scheduling component 134, and the application component 135, as discussed with respect to FIG. 1. In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. 1-8 which may illustrate various process flows.

As used in this description, the terms “module,” “components,” “database,” “module,” “system,” and the like are intended to refer to a computer-related entity, either hardware, firmware, a combination of hardware and software, software, or software in execution. For example, a module may be, but is not limited to being, a process running on a processor, a processor, an object, an executable, a thread of execution, a program, and/or a computer. By way of illustration, both an application running on a computing device and the computing device may be a module. One or more modules may reside within a process and/or thread of execution, and a module may be localized on one computer and/or distributed between two or more computers. In addition, these modules may execute from various computer readable media having various data structures stored thereon. The modules may communicate by way of local and/or remote processes such as in accordance with a signal having one or more data packets (e.g., data from one module interacting with another module in a local system, distributed system, and/or across a network such as the Internet with other systems by way of the signal).

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (“CD”), laser disc, optical disc, digital versatile disc (“DVD”), floppy disk and blue-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method comprising:
receiving global positioning system (GPS) data from a plurality of devices associated with a physical structure;
generating a virtual geofence around the physical structure based in part on GPS trajectory data derived from the GPS data;
determining one or more location attributes based on the virtual geofence; and
presenting, via an application, the one or more location attributes within a site profile.

2. The method of claim 1, wherein the one or more location attributes are one or more first location attributes, and further comprising:
collecting textual information corresponding to the physical structure;
identifying one or more second location attributes based on the textual information; and
presenting, via an application, the one or more second location attributes within the site profile.

3. The method of claim 2, wherein the one or more second location attributes include restroom availability, lumper information, breakroom availability, vending machine information, shower availability, wireless availability, overnight parking availability, safety requirements, service information, site procedure information, location type, hours of operation, closure information, appointment types, and/or contact information.

4. The method of claim 2, further comprising:
predicting an end to end service duration based on the first location attributes and/or the second location attributes; and
presenting, via the application, the one or more second location attributes within the site profile.

5. The method of claim 2, further comprising:
predicting, based on the first location attributes and/or the second location attributes, a delivery time associated with a lowest end to end service duration; and
presenting, via the application, the delivery time within the site profile.

6. The method of claim 1, wherein determining the one or more location attributes based on the virtual geofence comprises determining at least one of an entry point or exit point of the physical structure.

7. The method of claim 1, wherein determining the one or more location attributes based on the virtual geofence comprises determining at least one of inflow information or outflow information of the physical structure.

8. The method of claim 1, wherein determining the one or more location attributes based on the virtual geofence comprises determining at least one of arrival pattern information or departure pattern information of the physical structure.

9. The method of claim 1, wherein the plurality of devices are a first plurality of devices, and determining the one or more location attributes based on the virtual geofence comprises:
monitoring historic dwell time of a second plurality of devices based on the virtual geofence; and
determining a predicted dwell time for a device based on the historic dwell time and an appointment time.

10. The method of claim 1, wherein the one or more location attributes include average dwell time, likelihood of detainment, ingress information, egress information, restroom availability, lumper information, breakroom availability, vending machine information, shower availability, overnight parking availability, service information, site procedure information, location type, hours of operation, closure information, appointment types, contact information.

11. An apparatus comprising:
a memory; and
a processor in communication with the memory, wherein the processor is configured to:
receive global positioning system (GPS) data from a plurality of devices associated with a physical structure;
generate a virtual geofence around the physical structure based in part on GPS trajectory data derived from the GPS data;
determine one or more location attributes based on the virtual geofence; and
present, via an application, the one or more location attributes within a site profile.

12. The apparatus of claim 11, wherein the one or more location attributes are one or more first location attributes, and the processor is further configured to:
collect textual information corresponding to the physical structure;
identify one or more second location attributes based on the textual information; and
present, via an application, the one or more second location attributes within the site profile.

13. The apparatus of claim 12, wherein the one or more location attributes are one or more first location attributes, and the processor is further configured to:
predict an end to end service duration based on the first location attributes and/or the second location attributes; and
present, via the application, the one or more second location attributes within the site profile.

14. The apparatus of claim 12, wherein the one or more location attributes are one or more first location attributes, and the processor is further configured to:
predict, based on the first location attributes and/or the second location attributes, a delivery time associated with a lowest end to end service duration; and
present, via the application, the delivery time within the site profile.

15. The apparatus of claim 11, wherein to determine the one or more location attributes based on the virtual geofence, the processor is further configured to determine at least one of an entry point or exit point of the physical structure.

16. The apparatus of claim 11, wherein to determine the one or more location attributes based on the virtual geofence, the processor is further configured to determine at least one of inflow information or outflow information of the physical structure.

17. The apparatus of claim 11, wherein to determine the one or more location attributes based on the virtual geofence, the processor is further configured to determine at least one of arrival pattern information or departure pattern information of the physical structure.

18. The apparatus of claim 11, wherein the plurality of devices are a first plurality of devices, and to determine the one or more location attributes based on the virtual geofence, the processor is further configured to:
monitor historic dwell time of a second plurality of devices based on the virtual geofence; and
determine a predicted dwell time for a device based on the historic dwell time and an appointment time.

19. A non-transitory computer-readable device having instructions thereon that, when executed by at least one computing device, cause the at least one computing device to perform operations comprising:
receiving global positioning system (GPS) data from a plurality of devices associated with a physical structure;
generating a virtual geofence around the physical structure based in part on GPS trajectory data derived from the GPS data;
determining one or more location attributes based on the virtual geofence; and
presenting, via an application, the one or more location attributes within a site profile.

20. The non-transitory computer-readable device of claim 19, wherein the one or more location attributes are one or more first location attributes, and the operations further comprise:
collecting textual information corresponding to the physical structure;
identifying one or more second location attributes based on the textual information; and
presenting, via an application, the one or more second location attributes within the site profile.
